(19) United States
(12) Patent Application Publication
(10) Pub. No.: US 2010/0119822 A1
(43) Pub. Date: May 13, 2010

(54) CARBON NANOTUBE COPOLYMERS AND COMPOSITIONS AND METHODS OF USING THE SAME

(75) Inventors: Wen-Fang Hwang, Midland, MI (US); Peter Wu, Wichita, KS (US)

Correspondence Address: HOVEY WILLIAMS LLP, 10801 Mastin Blvd., Suite 1000, Overland Park, KS, 66210, US

(73) Assignee: SPIRIT AEROSYSTEMS, INC., Wichita, KS (US)

(21) Appl. No.: 12/616,327

(22) Filed: Nov. 11, 2009

Related U.S. Application Data
(60) Provisional application No. 61/113,484, filed on Nov. 11, 2008.

(51) Int. Cl. B32B 5/02; C08F 26/06; C08F 292/00

(52) U.S. Cl. 428/364; 526/259; 525/204; 977/742

(57) ABSTRACT

New carbon nanotube polymers and compositions are provided. The polymers comprise recurring blocks or units of carbon nanotubes and a compound other than a carbon nanotube. The compound is a polymeric or oligomeric block and is bonded to the carbon nanotube outer sidewall rather than to the carbon nanotube end, and is preferably a block copolymer of the compound and the carbon nanotube. The polymers can be used to prepare compositions that can be formed into products that are useful for building components present in airplanes.

### RELATED APPLICATIONS

This application claims the priority benefit of a provisional application entitled COMPOSITIONS, PROCESS, AND PRODUCTS OF COPOLYMERS OF REACTIVE POLYBENZAZOLES AND OTHER AROMATIC LIQUID CRYSTALLINE POLYMERS WITH FUNCTIONALIZED CARBON NANOTUBES (F-CNT), Ser. No. 61/113,484, filed Nov. 11, 2008, incorporated by reference herein.

### BACKGROUND OF THE INVENTION

1. Field of the Invention

The present invention is broadly concerned with novel carbon nanotube copolymers, and compositions and articles formed using those polymers.

2. Description of the Prior Art

Carbon nanotubes (CNTs) are single graphene sheets rolled up onto themselves to form cylindrical nanoscale tubes (See, Nature 1991, 354, 56-58; Nature 1993, 363, 605-607, each incorporated by reference herein). Single-walled carbon nanotubes (SWNTs) contain a single shell of carbon, while double-walled carbon nanotubes (DWNTs) or multi-walled carbon nanotubes (MWNTs) contain two or more concentric carbon shells.

CNTs possess a number of properties that make them highly desirable for use in a number of applications. They are extremely strong while simultaneously being very low in density. As a result of these properties, CNTs have been incorporated into polymer blends in order to increase the strength, modulus, and toughness of those blends. However, the lateral coherent strength of these composites has been lacking due to the fact that the rigid rod polymers commonly used tend to fibrillate easily when formed into fibers and are susceptible to degradation under elevated temperatures and humid conditions.

There is a need for improved CNT-polymer composite fibers that have high strength and a low weight while being resistant to thermal and moisture degradation.

### SUMMARY OF THE INVENTION

The present invention solves this problem by providing a polymer comprising recurring blocks or units of carbon nanotubes and a compound other than a carbon nanotube. The carbon nanotube presents an outer sidewall and the compound is bonded to that outer sidewall.

In another embodiment, the invention is concerned with a composition comprising a polymer dispersed or dissolved in a solvent system. The polymer comprises recurring blocks or units of carbon nanotubes and a compound other than a carbon nanotube. The carbon nanotube presents an outer sidewall, and the compound is bonded to that outer sidewall.

The invention is also directed towards an article formed from a polymer comprising recurring blocks or units of carbon nanotubes and a compound other than a carbon nanotube. The carbon nanotube presents an outer sidewall, and the compound is bonded to the outer sidewall.

### DETAILED DESCRIPTION OF THE PREFERRED EMBODIMENTS

The inventive polymer comprises carbon nanotubes copolymerized with another compound, with the chemical linkage between the carbon nanotubes and other compound being at the carbon nanotube sidewall. The carbon nanotubes can be single-walled, double-walled, multi-walled, or a mixture of the foregoing, although particularly preferred carbon nanotubes are single-walled. More preferably, the carbon nanotubes used in the present invention are ultrashort carbon nanotubes (US-CNTs), and even more preferably, ultrashort single-walled carbon nanotubes (US-SWNTs). “Ultrashort” as used herein refers to carbon nanotubes having a length of less than about 1,000 nm, preferably less than about 500 nm, more preferably less than about 100 nm, and even more preferably from about 5 nm to about 90 nm.

Although the number of walls affects the outer diameter of the carbon nanotubes, it is generally preferred that the carbon nanotubes used in the present invention have an outer diameter of less than about 4 nm, preferably less than about 3.5 nm, and more preferably less than about 2 nm. Thus, the aspect ratio (length divided by outer diameter) of the carbon nanotubes will be less than about 1,000, preferably less than about 100, and more preferably from about 5 to about 100.

The carbon nanotubes used in the present invention will preferably comprise an outer sidewall that has been functionalized with groups capable of reacting with the compound that is selected as the comonomer, co-oligomer, and/or co-polymer. (It will be appreciated by those having ordinary skill in the art that it is common in the art to use the term “sidewall” with respect to carbon nanotubes, even though that wall is curved and not a “side,” per se.) The functional group on the sidewalls of the SWNTs is an electron-deficient carbon group, but can generally be any group containing a carbon atom that can react in aprotic solvents or mineral acids an amine or other moiety on the monomer, oligomer, or small polymer to form amide or other linkages between the SWNTs and monomer, oligomer, or small polymer. Suitable electron-deficient groups include, but are not limited to, carboxylic acids (—COOH), —OH, acid halides (—COX, where X is a halogen atom), metal carboxylate salts, cyano groups, trihalomethyl groups, and combinations of the foregoing. Halogens in such electron-deficient carbon groups are typically fluorine, chlorine, or bromine, and more typically chlorine.

The following schematically depicts a functionalized US-SWNT according to the invention (not to scale).

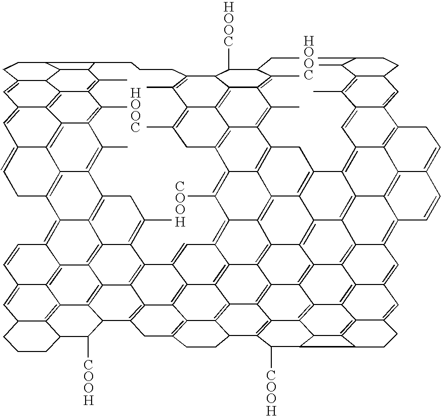

Of course, the —COOH groups shown in the above illustration could be replaced with any of the other functional groups discussed herein. The functionalized tubes could be synthesized in the functionalized form, or unfunctionalized carbon nanotubes could be functionalized following known procedures, including the one described in Example 2. Regardless, it is preferred that the ratio of functional groups:carbon atoms is from about 1:100 to about 1:5, more preferably from about 1:50 to about 1:5, and even more preferably from about 1:20 to about 1:5, provided the carbon nanotubes retain their tubular characteristics while maximizing solubility in the solvents typically used (such as those described herein).

The compounds for copolymerizing with the carbon nanotubes are any monomers, oligomers (as used herein, from about 5 to about 100, preferably from about 10 to about 100, and more preferably from about 50 to about 100 repeat units), and small polymers (as used herein, 100-200 repeat units) that are capable of reacting (i.e., “reactive compounds”) with the sidewall of a carbon nanotube or with the functional groups present on the carbon nanotube sidewall. Suitable compounds include those that are typically used to form rigid rod polymers, and preferably organic-based, liquid crystalline polymers. Aromatic polymers are particularly preferred.

Preferred such compounds will include reactive end groups selected from the group consisting of —OH, —NH, —NH₂, —SH, and mixtures of the foregoing, although it is particularly preferred that at least one reactive group at each end be —NH₂. Particularly preferred compounds for use in the inventive polymers include those selected from the group consisting of diaminoresorcinol dihydrochloride, terephthaloyl chloride, polybenzazoles, poly-2,5-(benzoxazole), aromatic polyamides, aromatic polyesters, polybenzimidazoles, polybenzdiazole, and mixtures of the foregoing. Preferred polybenzazoles include those selected from the group consisting of polybenzoxazole, and poly-p-phenylenebisbenzthiozole. The general formula for a polybenzazole (cis and trans, respectively) is

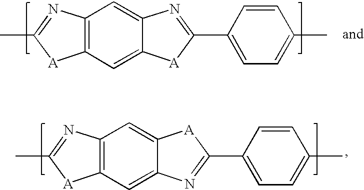

where each A is individually selected from the group consisting of —O—, —S—, and —NH—. The above compounds can be purchases commercially, or can be synthesized according to known methods, including the one described in Example 1.

The inventive polymer preferably comprises from about 0.1% by weight to about 99% by weight carbon nanotubes, more preferably from about 0.1% by weight to about 50% by weight carbon nanotubes, and even more preferably from about 0.1% by weight to about 5% by weight carbon nanotubes. The inventive polymer preferably comprises from about 1% by weight to about 99.9% by weight of the compound copolymerized with the carbon nanotubes, more preferably from about 50% by weight to about 99.9% by weight of that compound, and even more preferably from about 95% by weight to about 99.9% by weight of the compound. These percentages by weight are based upon the total weight of the polymer taken as 100% by weight. Furthermore, it is particularly preferred that the polymer be a block copolymer comprising blocks of carbon nanotubes and blocks of the compound.

It will be appreciated that the functionalization of the carbon nanotubes will result in a plurality of functional groups along the carbon nanotubes sidewalls, as shown above. Some or all of these groups may be reacted with the comonomer, co-oligomers, and/or copolymers described above. Scheme A provides a general schematic depiction of the morphology or structure that would be formed, although Scheme A is not to scale and is only a small “snapshot” of the very large inventive structures.

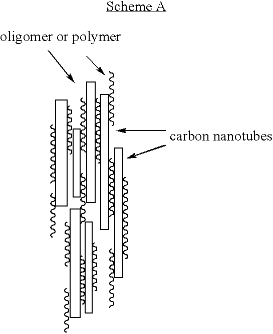

The above-described polymer can be prepared by in situ copolymerization of one or more of the above-described compounds (monomers, oligomers, or small polymers) in the presence of the carbon nanotubes. Alternatively, the compound can be formed into oligomers or small polymers first, using conventional techniques, followed by block copolymerization with the carbon nanotubes. Two preferred techniques are described in Examples 3 and 4 below.

Regardless of the technique chosen, the concentration of the reaction mixture should be designed so that it would be much greater than the critical concentration point. Thus, the reaction mixture will always be liquid crystalline, which means that the US-SWNTs and compound will align in a side-by-side manner in order to save space (a thermodynamically favorable condition). The viscosity of the reaction mixture will always be low to allow the reaction to proceed to completion due to the ease of mixing. The prior art is concerned with bonding the comonomers or copolymers at the end of the carbon nanotubes rather than along the sidewalls as is occurring in the present invention. The absence of side-wall functional groups in the prior art leads to networks with lower lateral strength. The present invention provides a significant advantage over the prior art in that the plurality of functional groups along the side-walls of US-SWNTs result in increased lateral strength of the resultant fibers through the plurality of chemical bonds formed between them.

The resulting polymer will have a tensile strength of at least about 1,000 mPa, preferably at least about 3,000 mPa, and more preferably from about 6,000 mPa to about 10,000 mPa. Furthermore, the resulting polymer will have a density of less than about 1.95 g/cm³, preferably less than about 1.9 g/cm³, and more preferably from about 1.8 g/cm³ to about 1.85 g/cm³.

Compositions containing this polymer dispersed or dissolved in a solvent system is an important next-generation carbon fiber technology. The solvent system can be the one in which the polymerization reaction took place, or any other solvent in which the inventive copolymer is soluble. These include solvents selected from the group consisting of N-methyl-2-pyrrolidone, dimethyl acetamide, N,N-dimethylformamide, 1,3 dimethyl-2-imidazolidinone, dimethylsulfoxide, and mixtures thereof. Most preferably, suitable solvents also include strong acids such as those selected from the group consisting of sulfuric acid, oleum (fuming sulfuric acid with dissolved SO₃ to remove trace water), methanesulfonic acid, polyphosphoric acids with various P₂O₅ content, other mineral acids, and mixtures thereof. Regardless of the solvent system, the inventive carbon nanotube copolymer is preferably present at a level of from about 5% to about 20% by weight, and more preferably from about 5% to about 10% by weight, based upon the total weight of the composition taken as 100% by weight.

The composition can be formed into a number of articles comprising a solid, self-sustaining body such as a fiber or a layer or film. Suitable applications include space, aerospace, compressed gas tank, wind blade, sporting good, and automotive technologies. This invention will be particularly beneficial in aerospace and space technologies for use in composites and composite structures, since high strength and light weight is particularly important in those areas.

### EXAMPLES

The following examples set forth preferred methods in accordance with the invention. It is to be understood, however, that these examples are provided by way of illustration, and nothing therein should be taken as a limitation upon the overall scope of the invention.

### Example 1

### Synthesis of Reactive PBO Oligomers and Prepolymers

A slight excess of diaminoresorcinol dihydrochloride (DAR) (1 eq.) would be combined with terephthaloyl chloride (TPC) (0.9379 eq.) to synthesize PBO oligomers that are aminophenol-terminated at both ends (see Scheme B below). The off-stoichiometry between the two monomers used in this reaction is to control the size of the oligomers (J. Polym. Sci., A46, 1265-1277 (2008), incorporated by reference herein). To make PBO oligomers with approximately 15 repeat units (n=15, in Scheme B), 5 g (or 23.44 mmol) of DAR and 4.46 g (21.98 mmol) of TPC would be added to a solvent mixture of 37 g of polyphosphoric acid (PPA with 84.5% P₂O₅) and 0.48 g of P₂O₅ (total P₂O₅ content in mixture would be 84.7 wt. %). The reaction mixture is then subjected to dehydrochlorination at 50° C. for 15 hours, after which an oligomerization step is carried out at 95° C. for 8 hours, 150° C. for 15 hours, and 190° C. for 24 hours.

The reaction mixture is then carefully poured into water to precipitate the product, which is filtered and dried. The product would then be ground to a fine powder and suspended in refluxing water. The solid is filtered, and the filter cake is washed with water and acetone followed by drying under vacuum at 170° C. This would yield a reactive PBO oligomer with a molar molecular weight of 3,874. The molecular weight can generally be determined by the inherent viscosity, which can be measured in a methane sulfonic acid (MSA, >99.5%) solution saturated with MSA anhydride at 25° C. to keep it moisture-free, at a concentration of 0.05 dL/g in a cross-arm viscometer. The weight-average molecular weight can then be calculated from the inherent viscosity using the equation, [η](dL/g)˜2.77×10⁻⁷×Mw^{1.8}.

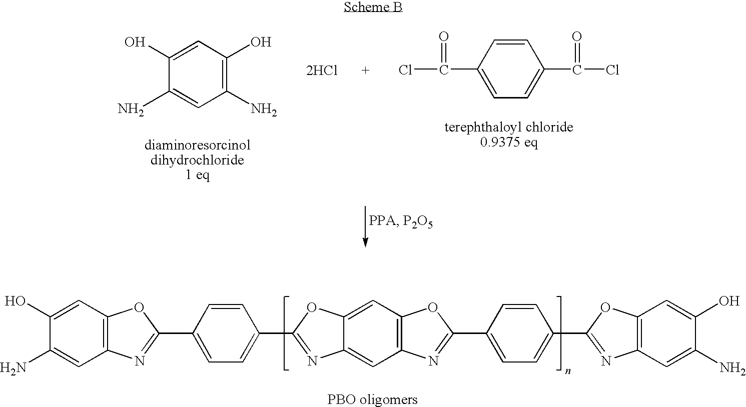

### Example 2

### Synthesis of Functionalized Ultra-Short SWNTs (US-SWNTs)

The synthesis of carboxylated, ultra-short single-walled carbon nanotubes (JACS 128, 10568 (2006), incorporated by reference herein) would involve a two-step, simultaneous cutting and functionalization process.

SWNTs having pristine sidewalls would first be dispersed in oleum (sulfuric acids with a 20-30% excess of SO₃) to swell the entangled nanotube ropes formed during nanotube production and open up the area between individual nanotubes for other chemical agents. Such chemical agents include cutting and functionalization agents, which will require access to these sidewalls (Science, 305, 1447 (2004), incorporated by reference herein). The swollen SWNT ropes will become flexible and mobile, rendering them easier to separate. Both raw SWNTs and/or purified SWNTs can be utilized in this procedure. However, using raw SWNTs is less efficient and impurities from the raw SWNTs might be carried forward; therefore, it's preferred to first purify raw SWNTs following conventional methods, such as those taught in Nano Letter 2, 385 (2002), incorporated by reference herein.

A disentanglement process is then used to break up the entangled SWNT network for easier access of the cutting/functionalization agents to the individual nanotube. After the soaking/swelling steps described above, an immersion blender such as a rotor/stator operating at high speed (e.g., 5,000-10,000 rpm) for up to 72 hours is used to disentangle the network in a vessel containing the SWNTs in oleum. This is also carried out under a nitrogen atmosphere. The SWNTs/oleum dispersion is then carefully poured into icy water (4:1 vol:vol water:SWNT/oleum). The black slurry is next vacuum filtered onto a 5-um TEFLON® membrane and completely washed with icy water and distilled water until neutralized to remove the residual acid. The black slurry is washed with methanol and ether to yield a fine powder, followed by vacuum drying.

Next, a cutting agent is contacted with the tubes. Specifically, 400 mg of the disentangled SWNTs prepared as described above (0.1 wt % or higher concentration) are dispersed in 200 mL of (with 20% excess SO₃) in an Erlenmeyer flask and stirred overnight under a blanket of dry nitrogen to ensure access by SO₃ for complete acid-intercalation. Subsequently, a mixture of 100 mL oleum (with 20% SO₃) and 100 mL 70% HNO₃ are slowly added, while stirring, into the SWNT/oleum dispersion, which is in an ice bath to maintain the dispersion's temperature as close to room temperature as possible. Afterwards, the SWNT dispersion is stirred at 65° C. for 2 hours. The dispersion should then be carefully poured into 1.2 L of icy nanopure water (e.g., obtained from a purification system sold by Barnstead Internationals, Dubuque, Iowa) or distilled water, or the dispersion should be cooled by an external ice bath to room temperature. The black slurry is then vacuum-filtered using a 5-μm TEFLON® membrane, which will retain most of the US-SWNTs. After most of the liquid has been pulled through the filter cake, the vacuum line is removed from the flask, and the filter cake stirred with 50 mL of methanol in a Büchner funnel using a spatula. Methanol is used for washing because the filtered acidic SWNT cake readily dissolves in water.

The particles are then coagulated by adding 200 mL of diethyl ether and stirring, which precipitates the US-SWNTs out of the solution. Little, if any, organic wash solvent will drain through the filter. The aqueous acidic filtrate is then discarded from the filter flask, vacuum is reapplied, and the methanol/diethyl ether wash liquid is pulled through the filter. The filter cake is washed with additional 200-mL portions of diethyl ether until the pH of the filtrate is neutral. The diethyl ether-wet filtered cake is transferred to a Petri dish or beaker, and the clumps are broken apart with a spatula to provide a fine, powdered US-SWNTs as the diethyl ether evaporates. The US-SWNTs is then vacuum-dried at room temperature overnight, typically yielding 440 mg of product. The increase in mass is due to the significant increase in functionalization of SWNTs. The resultant US-SWNTs are generally less than 100 nm in length and have a high level of carboxylic acid groups on the sidewalls, as indicated by a G/D ratio of approximately one of the Raman spectrum (see JACS 128, 10568 (2006), incorporated by reference herein).

### Example 3

### Copolymerization of US-SWNTs with Benzoxazole Monomers

Before the preparation of US-SWNT/PBO copolymers, the carboxylic acids groups on US-SWNTs are converted to acid chlorides (i.e., —COOH converted to —COCl) by the method described in Science 280, 1253 (1998), incorporated by reference herein. To create a copolymer of US-SWNTs with PBO, 0.05 grams of US-SWNTs (with either —COOH or —COCl functionality) are added to a total of 4.95 grams of equimolar amounts (12 mmol each) of DAR (2.5 g grams) and TPC (2.45 grams) in a resin kettle to create a 99:1 PBO:US-SWNT wt % reaction mixture, along with about 23.5 g of PPA and 12.3 g of phosphorous pentoxide (P₂O₅). The concentration of the starting materials in the PPA/P₂O₅ solvent is 12.3 wt/wt % to ensure that the concentration of resultant copolymers in the solvent will be in the optically anisotropic range. The DAR-TPC-US-SWNT mixture is allowed to stir for 16 hours at 55° C. to facilitate dechlorination of the monomer species. To ensure the preparation of high molecular weight copolymers, stirring is best accomplished by using a high-shear mixer/reactor such as high-shear twin screw reactor. Additional P₂O₅ is added to the mixture to maintain the effective concentration of PPA at about 82%, after which the temperature is increased to 75° C., and the mixture allowed to stir for another 8 hours. Polymerization is induced by increasing the temperature to 100° C., raising the PPA concentration to about 84.3%, and stirring the mixture for an additional 16 hours. A series of time and temperature adjustments can be made to foster the continuing polymerization reaction. The material is allowed to stir for 8 hours at 125° C., then for 16 hours at 150° C., and finally at 185° C. for 24 hours. Stir opalescence will be observed.

### Example 4

### Block Copolymerization of PBO Oligomers with US-SWNTs

In this procedure, 0.1 grams of US-SWNTs (with either —COOH or —COCl functionality with —COCl being preferred) are added to 9.9 grams of amino-phenol terminated PBO oligomers in a high shear reactor. This creates a 99:1 PBO:US-SWNT wt/wt % reaction mixture in 43.9 g of PPA and 23 g of phosphorous pentoxide (P₂O₅). As was the case in Example 3, P₂O₅ is added to scavenge water in order to facilitate the formation of chemical links between the US-SWNTs and PBO blocks. The concentration of the starting materials in the PPA/P₂O₅ solvent is 13 wt/wt % in order to ensure that the concentration of resultant block copolymers in the solvent will be in the optically anisotropic range. The reaction mixture should be allowed to stir for 16 hours at 55° C. to facilitate dechlorination of the reactants (in the event that US-SWNTs with —COCl are utilized). To ensure completion of the block copolymerization, stirring is best accomplished via a high-shear mixer/reactor such as high-shear twin screw reactor. Additional P₂O₅ is added to the mixture to maintain the effective concentration of PPA at about 82%. The temperature is then gradually increased to 150° C. for about 24 hours (dependant on the effectiveness of mixing/stirring in the reactor), or until the mixture becomes smoothly homogeneous. Stir opalescence should be observed.

Regardless of the polymerization process utilized, the resultant liquid crystalline solution (also called “dope”) can be shaped through a spinneret or film die followed by coagulation of the shaped solution in a coagulation bath using compositions and coagulation rates known in the art. Alternatively the shaped solution can be consolidated in a forced-air oven or a vacuum oven at the appropriate temperature to evaporate the solvent.

As will be appreciated by those having ordinary skill in the art, there is an air-gap between the exit of the spinneret or the shaping die and the top surface of the coagulation bath. Further, the speed of the take-up roll (drum) is higher than the linear extrusion rate of the polymer solution. The ratio between the take-up speed and the extrusion rate is referred to as the spin-draw ratio (SDR), and it is preferred that the SDR be as high as possible (e.g., at least about 2, and preferably from about 3 to about 150) for the greatest possible axial orientation of the composite fibers or films. In some embodiments, providing a series of post-treatments of the shaped articles such as, but not limited to, wet-drawing to further the axial orientation of the fibers or films, washing and drying to eliminate the residual solvent, annealing, heat treating, and/or pressure molding the resultant product can be carried out in order to further enhance the properties of the shaped articles.

We claim:

1. A polymer comprising recurring units of carbon nanotubes and a compound other than a carbon nanotube, said carbon nanotube presenting an outer sidewall and said compound being bonded to said outer sidewall.

2. The polymer of claim 1, wherein said compound is bonded to a functional group present on said outer sidewall.

3. The polymer of claim 2, wherein said functional group is selected from the group consisting of —COOH, —OH, acid halides, metal carboxylate salts, cyano groups, trihalomethyl groups, and combinations of the foregoing.

4. The polymer of claim 1, wherein said carbon nanotubes are selected from the group consisting of single-walled nanotubes, double-walled nanotubes, multi-walled carbon nanotubes, and mixtures of the foregoing.

5. The polymer of claim 1, wherein said carbon nanotubes have a length of less than about 1,000 nm.

6. The polymer of claim 1, wherein said carbon nanotubes have an aspect ratio of less than about 1,000.

7. The polymer of claim 1, wherein said polymer comprises a block copolymer of said carbon nanotubes and said compound.

8. The polymer of claim 1, wherein said polymer comprises from about 0.1% by weight to about 99% carbon nanotubes and from about 1% by weight to about 99.9% by weight of said compound, based upon the total weight of the polymer taken as 100% by weight.

9. The polymer of claim 1, wherein said compound comprises reactive end groups selected from the group consisting of —OH, —NH, —NH₂, —SH, and mixtures of the foregoing, with at least one reactive end group at each end comprising —NH₂.

10. The polymer of claim 1, wherein said compound is a monomer or oligomer and is selected from the group consisting of diaminoresorcinol dihydrochloride, terephthaloyl chloride, polybenzazoles, poly-2,5-(benzoxazole), aromatic polyamides, aromatic polyesters, polybenzimidazoles, polybenzdiazole, and mixtures of the foregoing.

11. The polymer of claim 1, wherein said compound is an oligomer having from about 5 mer units to about 100 mer units.

12. In a composition comprising a polymer dispersed or dissolved in a solvent system, the improvement being that said polymer comprises recurring units of carbon nanotubes and a compound other than a carbon nanotube, said carbon nanotube presenting an outer sidewall and said compound being bonded to said outer sidewall.

13. The composition of claim 12, wherein said compound is bonded to a functional group present on said outer sidewall.

14. The composition of claim 13, wherein said functional group is selected from the group consisting of —COOH, —OH, acid halides, metal carboxylate salts, cyano groups, trihalomethyl groups, and combinations of the foregoing.

15. The composition of claim 12, wherein said carbon nanotubes are selected from the group consisting of single-walled nanotubes, double-walled nanotubes, multi-walled carbon nanotubes, and mixtures of the foregoing.

16. The composition of claim 12, wherein said carbon nanotubes have a length of less than about 1,000 nm.

17. The composition of claim 12, wherein said carbon nanotubes have an aspect ratio of less than about 1,000.

18. The composition of claim 12, wherein said polymer comprises a block copolymer of said carbon nanotubes and said compound.

19. The composition of claim 12, wherein said polymer comprises from about 0.1% by weight to about 99% carbon nanotubes and from about 1% by weight to about 99.9% by weight of said compound, based upon the total weight of the polymer taken as 100% by weight.

20. The composition of claim 12, wherein said compound comprises reactive end groups selected from the group consisting of —OH, —NH, —NH₂, —SH, and mixtures of the foregoing, with at least one reactive end group at each end comprising —NH₂.

21. The composition of claim 12, wherein said compound is a monomer or oligomer and is selected from the group consisting of diaminoresorcinol dihydrochloride, terephthaloyl chloride, polybenzazoles, poly-2,5-(benzoxazole), aromatic polyamides, aromatic polyesters, polybenzimidazole, polybenzdiazole, and mixtures of the foregoing.

22. An article formed from a polymer comprising recurring units of carbon nanotubes and a compound other than a carbon nanotube, said carbon nanotube presenting an outer sidewall and said compound being bonded to said outer sidewall.

23. The article of claim 22, said article being in the form of a layer or a fiber.

24. The article of claim 22, wherein said compound is bonded to a functional group present on said outer sidewall.

25. The article of claim 22, wherein said carbon nanotubes have a length of less than about 1,000 nm.

26. The article of claim 22, wherein said carbon nanotubes have an aspect ratio of less than about 1,000.

27. The article of claim 22, wherein said polymer comprises a block copolymer of said carbon nanotubes and said compound.

28. The article of claim 22, wherein said compound is a monomer or oligomer and is selected from the group consisting of diaminoresorcinol dihydrochloride, terephthaloyl chloride, polybenzazoles, poly-2,5-(benzoxazole), aromatic polyamides, aromatic polyesters, polybenzimidazoles, polybenzdiazole, and mixtures of the foregoing.
